(19) United States
(12) Patent Application Publication
(10) Pub. No.: US 2018/0208164 A1
(43) Pub. Date: Jul. 26, 2018

(54) APPARATUS AND METHOD FOR RESPONDING TO A TARGET VEHICLE IN A LATERAL POSITION

(71) Applicant: Bendix Commercial Vehicle Systems LLC, Elyria, OH (US)

(72) Inventors: Jeffrey M. Carbaugh, Avon Lake, OH (US); Robert J. Custer, Westlake, OH (US); Andrew L. Kennedy, Elyria, OH (US); Subashish Sasmal, Elyria, OH (US)

(21) Appl. No.: 15/414,054

(22) Filed: Jan. 24, 2017

(51) Int. Cl. B60T 7/22; G08G 1/16; G05D 1/02; B60T 8/17; B60R 1/00; B60T 17/22; B60T 8/171; G01S 13/86; G01S 13/93

(52) U.S. Cl. CPC B60T 7/22; G08G 1/166; G05D 1/0257; G05D 1/0246; B60T 8/17; B60R 1/00; G01S 2013/9346; B60T 8/171; G01S 13/867; G01S 13/931; B60R 2300/80; B60Y 2300/09; B60T 17/22

(57) ABSTRACT

A controller for a driver assistance system comprises an output for transmitting a braking control signal and control logic. The control logic is capable of identifying a target vehicle, determining an intervention zone and determining an edge zone. The controller will transmit the braking control signal to request activation of the brakes on the host vehicle in response to the edge zone being equal to or less than zero and the target vehicle being within the intervention zone.

### BACKGROUND

The present invention relates to embodiments of a driver assistance system that responds to a target vehicle moving laterally with respect to a host vehicle. Today's driver assistance systems identify target vehicles in front of or to the side of the host vehicle. Safe longitudinal and lateral distances between the host vehicle and the target vehicle are typically predefined. If the calculated distance between the host vehicle and the target vehicle is less than the predefined distance, an automated braking action will engage to mitigate a collision. If a calculated distance to a target vehicle becomes greater than the predefined safe lateral distance, the automatic braking action may disengage. However, varying actual widths of a target vehicle may cause the braking system to automatically engage or disengage at inappropriate times. Therefore, an improvement to a system for responding to a target vehicle in a lateral position is desired.

### SUMMARY

Various embodiments of a controller for a driver assistance system comprise an output for transmitting a braking control signal and control logic. The control logic is capable of identifying a target vehicle; determining an intervention zone; determining an edge zone and transmitting the braking control signal to request activation of the brakes on the host vehicle in response to the edge zone being equal to or less than zero and the target vehicle being within the intervention zone.

In accordance with another aspect, various embodiments of a driver assistance system comprise a radar controller for identifying a target vehicle and a camera controller for identifying the target vehicle and for determining a width of the target vehicle. At least one of the radar controller and the camera controller is capable of determining an edge zone as a function of the width of the target vehicle and a width of a host vehicle, determining an intervention zone between the target vehicle and the host vehicle, and transmitting a braking control signal in response to the edge zone being less than or equal to zero and the target vehicle being within an intervention zone.

In accordance with yet another aspect, various embodiments of a method for controlling a host vehicle having a driver assistance system comprise identifying a target vehicle in response to a video signal and a radar signal; determining a width of the target vehicle; determining an edge zone as a function of the width of the target vehicle and a width of a host vehicle; determining an intervention zone between the target vehicle and the host vehicle, and activating the service brakes on the host vehicle in response to the target vehicle being within the edge zone and within the intervention zone.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates an automated braking system according to one example of the present invention.

FIGS. 2A, 2B illustrate a roadway having a host vehicle equipped with the automated braking system of FIG. 1 and a target vehicle.

FIG. 3 illustrates a method of detecting and responding to a target vehicle in a lateral position.

### DETAILED DESCRIPTION

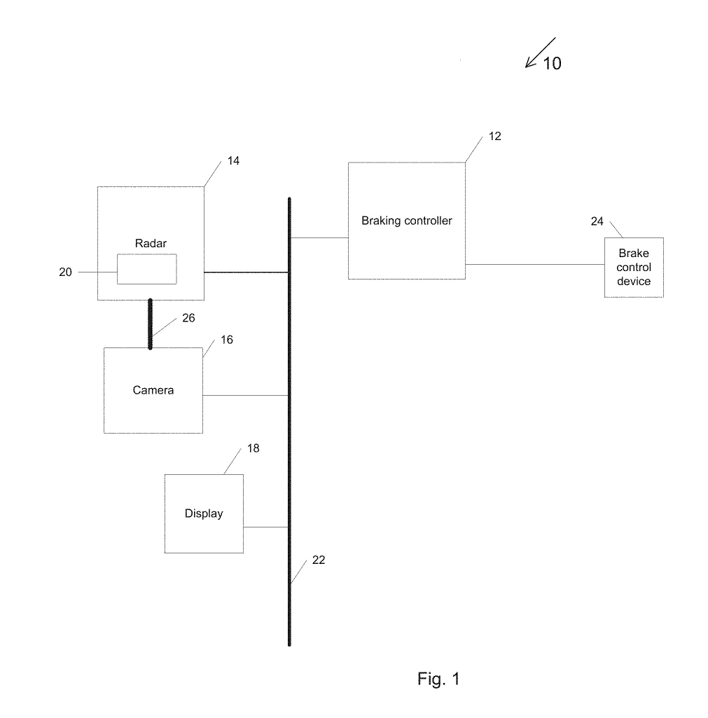

FIG. 1 illustrates a driver assistance system (DAS) 10 for a commercial vehicle. The DAS 10 may be a Bendix® Wingman® Fusion™ system available from Bendix Commercial Vehicle Systems LLC of Elyria, Ohio.

The DAS 10 includes a radar controller 14. The radar controller 14 is mounted on the lower front of a host vehicle, typically proximate to the bumper. The radar controller 14 is programmed by the vehicle manufacturer with the distance from the radar controller 14 mounting location to the centerline of the host vehicle. The radar controller 14 transmits and receives radar signals, which are electromagnetic waves used to detect an object's presence, longitudinal distance, lateral distance, speed and direction with respect to the host vehicle. The radar controller 14 can detect multiple stationary or moving objects within a wide range to the front and sides of the host vehicle.

The radar controller 14 includes a processor with control logic 20 for receiving and transmitting messages to control the DAS 10. The control logic 20 may include volatile, non-volatile memory, solid state memory, flash memory, random-access memory (RAM), read-only memory (ROM), electronic erasable programmable read-only memory (EEPROM), variants of the foregoing memory types, combinations thereof, and/or any other type(s) of memory suitable for providing the described functionality and/or storing computer-executable instructions for execution by the control logic 20.

The control logic 20 may determine the center of an object using the radar signals. The control logic 20 may also determine an intervention zone, where a threat of a possible collision with the object exists due to the longitudinal distance, lateral distance and relative velocity of the object with respect to the host vehicle. The control logic 20 may also determine an edge zone based on the lateral offset of the detected object from the host vehicle and the host vehicle size.

The DAS 10 includes at least one camera controller 16. The camera controller 16 is mounted on the upper front of the host vehicle, typically proximate to the top of the windshield. The location of the camera controller 16 on the host vehicle is programmed by the vehicle manufacturer as the measurement from the mounting location of the camera controller 16 to the right front wheel edge and left front wheel edge of the host vehicle. The camera controller 16 is also programmed by the vehicle manufacturer with the distance from the camera controller 16 to the centerline of the host vehicle. This mounting location information is used to determine the host vehicle width. The camera controller 16 uses video signals to detect an object's presence, size, longitudinal distance and lateral distance with respect to the host vehicle. The camera controller 16 can detect multiple stationary or moving objects within a wide range to the front and sides of the host vehicle. The video signal from the camera controller 16 can be used to determine the width of a detected object.

The DAS 10 includes a proprietary vehicle communications bus 26 for communications between the radar controller 14 and the camera controller 16. The control logic 20 is capable of receiving the video signals from the camera controller 16 on the proprietary communications bus 26. The video signals may also include the width of the detected object. The radar controller 14 may also transmit the radar signals on the proprietary communications bus 26. The information from the radar signals and video signals is used by the control logic 20 to determine the lateral offset of the detected object from the host vehicle.

The DAS 10 may include a display 18 in the cab of the host vehicle. The display 18 may show the distance of the host vehicle from the detected object and a preprogrammed following distance. The display 18 may show the status of the DAS 10 or other systems on the host vehicle.

The DAS 10 includes a braking system controller 12. The braking system controller 12 receives braking control signals and controls the service brakes of the host vehicle. The braking system controller 12 includes an output for communicating with at least one brake control device 24. The brake control device 24 may be an electro-pneumatic device that provides air to the service brakes on a wheel end in response to control signals from the braking system controller 12.

The DAS 10 also communicates using a public vehicle communications bus 22 connected to the radar controller 14, the camera controller 16, the display 18, the braking system controller 12 and other controllers on the vehicle. The radar controller 14 may transmit a braking control signal on the public vehicle communications bus 22 to the braking system controller 12. The radar controller 14 can also transmit a braking activity indicator, a distance to the detected object and a status signal to the display 18.

In another example, the camera controller 16, the braking system controller 12 or another stand alone controller may include control logic having the functionality to receive the video signals and the radar signals. That controller would then make the determination of the lateral offset of the detected object from the host vehicle from the received information.

Therefore, a controller for a driver assistance system comprises an output for transmitting a braking control signal and control logic. The control logic is capable of identifying a target vehicle; determining an intervention zone; determining an edge zone and transmitting the braking control signal to request activation of the brakes on the host vehicle in response to the edge zone being equal to or less than zero and the target vehicle being within the intervention zone.

A driver assistance system comprises a radar controller for identifying a target vehicle and a camera controller for identifying the target vehicle and for determining a width of the target vehicle. At least one of the radar controller and the camera controller is capable of determining an edge zone as a function of the width of the target vehicle and a width of a host vehicle, determining an intervention zone between the target vehicle and the host vehicle, and transmitting a braking control signal in response to the edge zone being less than or equal to zero and the target vehicle being within an intervention zone.

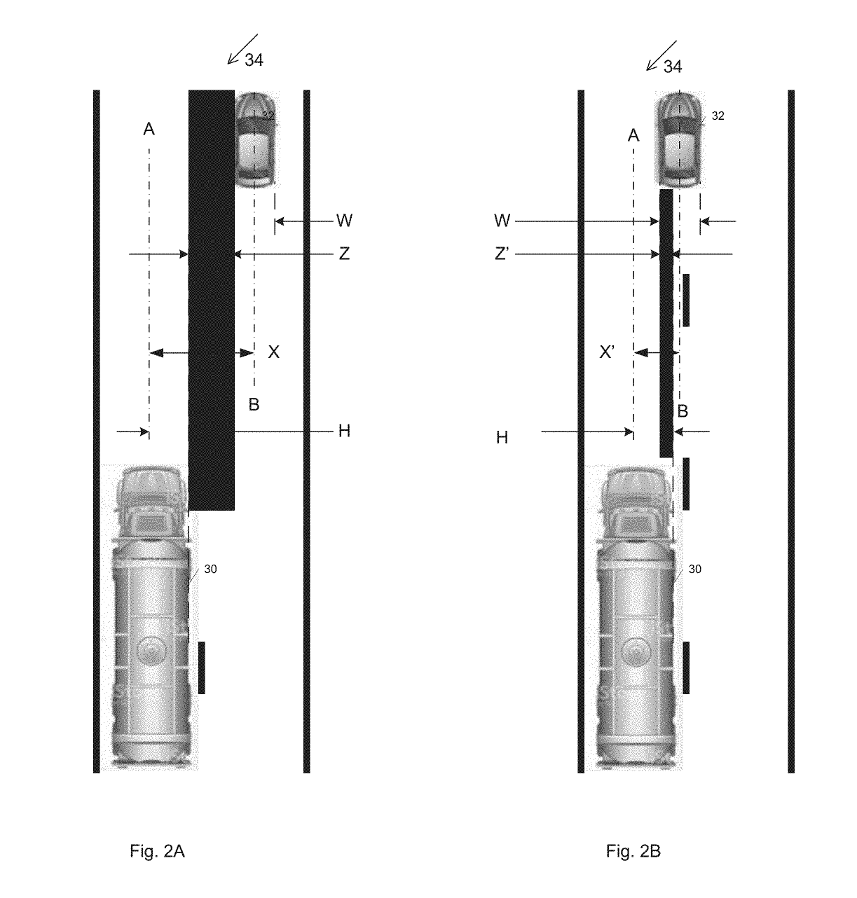

FIG. 2A illustrates a two lane roadway 34 having a host vehicle 30, equipped with the DAS 10, and a target vehicle 32. The host vehicle 30 and the target vehicle 32 are traveling in the same direction on the roadway 34.

In this example, the radar controller 14 and/or the camera controller 16 detects the target vehicle 32 according to the known operation of the DAS 10. The radar controller 14 determines the longitudinal distance between the host vehicle 30 and the target vehicle 32. The radar controller 14 determines if the target vehicle 32 is within an intervention zone. The intervention zone can be determined using different methods, such as the relative velocity between the host vehicle 30 and the target vehicle 32 is above a predetermined level, a time to collision is less than a predetermined time, a longitudinal distance is less than a predetermined distance or any combination of these factors.

The control logic 20 determines an Edge Zone Value Z. The control logic 20 receives a Wheel Edge Value H from the camera controller 16. Wheel Edge Value H is the distance from the right wheel edge to the Centerline A of the host vehicle 30 if a target vehicle is traveling to the right side of the host vehicle. Wheel Edge Value H is the distance from the left wheel edge to the Centerline A of the host vehicle if the target vehicle is traveling to the left side of the host vehicle. Centerline A is known due to the programmed mounting location of the camera controller 16. In one example, a width of the host vehicle 30 is about 2.4 meters. Assuming the camera controller 16 is mounted in the center of the host vehicle, the known Wheel Edge Value H is then about 1.2 m from the mounting location of the camera controller 16.

The camera controller 16 determines the Width W of the target vehicle 32 from the video signals. In one example, the Width W of the target vehicle 32 is determined to be about 1.8 m. From the Width W, the Centerline B of the target vehicle 32 is determined. The Centerline B is about 0.9 m from the edge of the target vehicle 32. The control logic 20 then determines a Lateral Offset Value X of the target vehicle 32 from the host vehicle 30. The Lateral Offset Value X is determined from the known Centerline A of the host vehicle 30 to the determined Centerline B of the target vehicle 32. In this example, Lateral Offset Value X is determined to be 3.1 m.

The Edge Zone Value Z is then calculated as the absolute value of Lateral Offset Value X minus the Width W of the target vehicle 32 divided by 2 minus the absolute value of the Wheel Edge Value H. The absolute value is used because the target vehicle 32 may be either to the right forward edge of the host vehicle 30 or to the left forward edge of the host vehicle 30. The formula for the Edge Zone Value Z is expressed below:

$$Z = \{ \vert X \vert - \frac{W}{2} - \vert H \vert \}$$

For the example shown in FIG. 2A, the Edge Zone Value Z is 1.0 m and is therefore greater than zero. As long as this Edge Zone Value Z is greater than zero, the DAS 10 proceeds to operate as normal by continuing to monitor the target vehicle 32 and determine if the target vehicle 32 is within the intervention zone. The Edge Zone Value Z is also continually re-calculated as long as the target vehicle 32 is within the field of view of the radar controller 14 and/or the camera controller 16.

FIG. 2B illustrates the same two lane roadway 34 having the host vehicle 30 and the target vehicle 32 traveling in the same direction. In FIG. 2B however, the target vehicle 32 has shifted its lateral position, as if moving into the same lane of travel as the host vehicle 30. The Width W of the target vehicle 32 and the Wheel Edge Value H of the host vehicle 30 remain the same. However, the DAS 10 calculates a new Edge Zone Value Z′ because the Lateral Offset Value X′ has changed with respect to the target vehicle 32. In the example shown in FIG. 2B, the Edge Zone Value Z′ is less than zero because the Lateral Offset Value X′ has decreased. As long as the target vehicle 32 is in the intervention zone, the DAS 10 will intervene with automated braking to mitigate a collision.

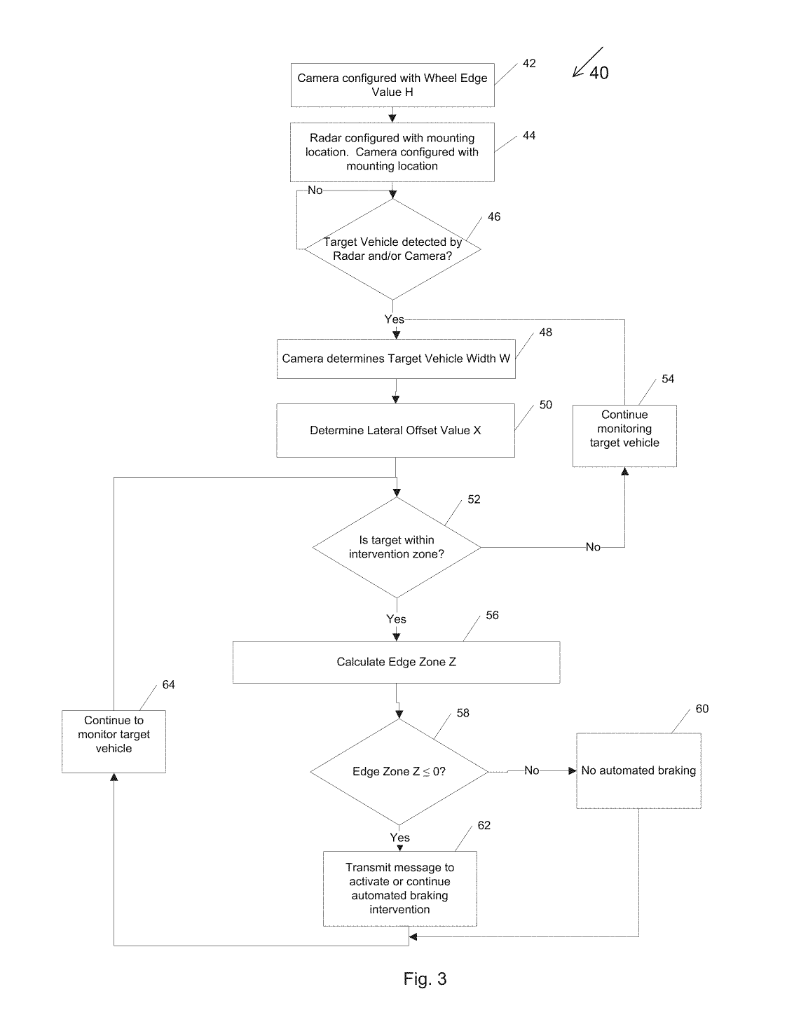

FIG. 3 illustrates a method 40 of responding to a target vehicle in a lateral position according to an example of the present invention. In step 42, the camera controller 16 is configured with the Wheel Edge Value H of the host vehicle 30. This Wheel Edge Value H is programmed at the vehicle manufacturer when the camera controller 16 is installed. In this example, the Wheel Edge Value H is the distance from the camera controller 16 to the right front wheel end edge of the host vehicle 30.

In step 44, the radar controller 14 is configured by the vehicle manufacturer with the distance from the radar controller 14 mounting location to the Centerline A of the host vehicle 30. The camera controller 16 is configured by the vehicle manufacturer with the distance from the camera controller 16 mounting location to the Centerline A of the host vehicle 30. Both the radar controller 14 and the camera controller 16 are mounted generally along the Centerline A of the host vehicle 30.

During vehicle operation, the radar controller 14 and camera controller 16 will scan for an object, such as target vehicle 32, using known algorithms. In step 46, it is determined whether the radar controller 14 and/or the camera controller 16 have detected a target vehicle. Target vehicles may be detected to the left, right or center of the lane of travel of the host vehicle 30. If no target vehicle is detected, the method 40 remains at step 46.

In step 48, when a target vehicle 32 is detected, the camera controller 16 determines the Width W of the target vehicle. If multiple target vehicles are detected, the data is collected for each target vehicle. The control logic 20 receives the width of the target vehicle 32 from the camera controller 16. The control logic 20 uses the width to learn the approximate Centerline B of the target vehicle 32. From this information, the control logic 20 determines the Lateral Offset Value X from the Centerline A of the host vehicle 30 to the Centerline B of the target vehicle 32 in step 50.

In step 52, the control logic 20 determines if the target vehicle 32 is within an intervention zone. The intervention zone is an area wherein a threat of a possible collision with the target vehicle 32 exists due to the longitudinal distance, lateral distance and relative velocity of the target vehicle 32 with respect to the host vehicle 30. In one example, the radar controller 14 and camera controller 16 work together to determine the intervention zone. The intervention zone is determined in a known manner. If the target vehicle 32 is outside of the intervention zone, the method 40 proceeds to step 54 where the target vehicle 32 continues to be monitored. The method 40 then returns to step 48 to determine the Width W and the Lateral Vehicle Offset X.

If the target vehicle 32 is within the intervention zone, the method 40 proceeds to step 56. The control logic 20 calculates the Edge Zone Value Z by subtracting half of the Width W of the target vehicle 32 and the absolute value of the Wheel Edge Value H of the host vehicle 30 from the absolute value of the Lateral Offset Value X. Alternatively, the Edge Zone Value Z may be calculated continually even if the target vehicle 32 is outside of the intervention zone.

In step 58, the control logic 20 determines if the Edge Zone Value Z is less than or equal to zero. If the Edge Zone Value Z is greater than zero, the method 40 proceeds to step 60. In step 60, the control logic 20 determines that collision mitigation in the form of automated braking is not required. The control logic 20 will not transmit, or will stop transmitting, a braking control signal. The method 40 then continues to step 64 where the target vehicle 32 continues to be monitored.

If the Edge Zone Value Z is less than or equal to zero, or the target vehicle 32 is within the edge zone, the control logic 20 will transmit a braking control signal on the vehicle communications bus 22 in step 62. The braking system controller 12 receives the braking control signal and will activate or continue to activate the braking control device 24 to mitigate any possible collision with the target vehicle 32. The braking control device 24 is connected to the service brakes of the host vehicle 30. The control logic 20 may also transmit a signal on the vehicle communications bus 22 indicating the transmission of the braking control signal. The display 18 may also indicate the braking intervention to the driver of the host vehicle 30 when the display 18 receives an indicator signal from the control logic 20.

In another example, the Edge Zone Value Z may be compared to a value slightly greater than zero to ensure that there is ample lateral distance between the target vehicle 32 and the host vehicle 30.

The method 40 then continues to step 64 where the target vehicle continues to be monitored. Step 64 returns the method 40 to step 52.

Therefore, a method for controlling a host vehicle having a driver assistance system comprise identifying a target vehicle in response to a video signal and a radar signal; determining a width of the target vehicle; determining an edge zone as a function of the width of the target vehicle and a width of a host vehicle; determining an intervention zone between the target vehicle and the host vehicle, and activating the service brakes on the host vehicle in response to the target vehicle being within the edge zone and within the intervention zone.

This inventive controller and method are preferable to a prior art system of setting a predefined lateral offset based solely on a centerline of the host vehicle and a target vehicle. The method herein defined will minimize a collision between a target vehicle and a host vehicle since the width of the target vehicle is accurately estimated and braking can intervene sooner as required if the target vehicle is overlapping the travel path of the host vehicle. The control logic for performing the method can be located in the radar controller, the camera controller, the braking system controller or another stand alone controller on the host vehicle.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A controller for a driver assistance system on a host vehicle comprising:
an output for transmitting a braking control signal; and
control logic, the control logic capable of:
identifying a target vehicle;
determining an intervention zone between the host vehicle and the target vehicle;
determining an edge zone value, wherein the edge zone value is a function of the lateral offset between the host vehicle and the target vehicle; and
transmitting the braking control signal to request activation of the brakes on the host vehicle in response to the edge zone value being equal to or less than zero and the target vehicle being within the intervention zone.

2. The controller as in claim 1, further comprising an input for receiving a video signal; wherein the control logic is further capable of receiving a width of the target vehicle at the input for receiving the video signal.

3. The controller as in claim 2, wherein the edge zone value is a function of a host vehicle width and the target vehicle width.

4. The controller as in claim 3, wherein the host vehicle width is based on the distance from a wheel edge of the host vehicle to a mounting location of the controller.

5. The controller as in claim 4, wherein the mounting location of the controller on the host vehicle is programmed into the control logic.

6. The controller as in claim 1, wherein the controller includes a radar for identifying the target vehicle.

7. The controller as in claim 6, further comprising an input for receiving a video signal; wherein the control logic is further capable of determining the intervention zone by using the radar and the video signal.

8. The controller as in claim 1, further comprising an output for transmitting a status signal, wherein the status signal is indicative of the braking control signal status.

9. A driver assistance system comprising:
a radar controller for identifying a target vehicle;
a camera controller for identifying the target vehicle and for determining a width of the target vehicle;
wherein at least one of the radar controller and the camera controller is capable of:
determining an edge zone value as a function of the width of the target vehicle, a width of a host vehicle and the lateral offset between the target vehicle and the host vehicle;
determining an intervention zone between the target vehicle and the host vehicle; and
transmitting a braking control signal in response to the edge zone value being less than or equal to zero and the target vehicle being within the intervention zone.

10. The driver assistance system as in claim 9, further comprising: a braking controller for receiving the braking control signal and activating the service brakes in response to the braking control signal.

11. The driver assistance system as in claim 10, wherein the radar controller and the camera controller communicate using a proprietary communication bus and the radar controller and camera controller communicate with the braking controller using a vehicle communications bus.

12. The driver assistance system as in claim 9, further comprising a display for indicating the presence of the target vehicle in the intervention zone and a status of the braking control signal.

13. A method for controlling a host vehicle having a driver assistance system comprising:
identifying a target vehicle in response to a video signal and a radar signal;
determining a width of the target vehicle;
determining an edge zone value as a function of the width of the target vehicle, a width of a host vehicle and a lateral offset between the target vehicle and the host vehicle;
determining an intervention zone between the target vehicle and the host vehicle; and
activating the service brakes on the host vehicle in response to the edge zone value being less than or equal to zero and the target vehicle being within the intervention zone.

14. The method as in claim 13, further comprising: programming the driver assistance system with a width of the host vehicle.

15. The method as in claim 13, wherein determining the width of the target vehicle comprises using the video signal.

16. The method as in claim 13, further comprising releasing the service brakes in response to the edge zone value being greater than zero.

17. The method as in claim 13, wherein determining the intervention zone comprises using both the video signal and the radar signal.
